(19) United States
(12) Patent Application Publication
(10) Pub. No.: US 2023/0356511 A1
(43) Pub. Date: Nov. 9, 2023

(54) MULTILAYER FILM AND METHOD FOR PRODUCING SAME

(71) Applicant: DENKA COMPANY LIMITED, Tokyo (JP)

(72) Inventors: Kota NAGAOKA, Tokyo (JP); Noriaki YASUMOTO, Tokyo (JP); Keiji TAKANO, Tokyo (JP)

(21) Appl. No.: 18/016,822

(22) PCT Filed: Jul. 14, 2021
(86) PCT No.: PCT/JP2021/026511

§ 371 Date: Jul. 28, 2023

(30) Foreign Application Priority Data
Jul. 30, 2020 (JP) 2020-129772

(51) Int. Cl. B32B 27/08; B32B 27/30; B32B 7/06; B32B 27/36; B32B 27/18

(52) U.S. Cl. CPC B32B 27/08; B32B 27/304; B32B 7/06; B32B 27/36; B32B 27/308; B32B 27/18; B32B 2307/748; B32B 2307/538; B32B 2307/54; B32B 2270/00; B32B 2307/518; B32B 2255/10; B32B 2255/26; B32B 2307/7376; B32B 2307/414; B32B 2307/5825; B32B 2451/00; B32B 2605/00; B29C 48/0021

(57) ABSTRACT

The present invention provides a multilayer film which is provided with a vinylidene fluoride resin-containing layer that has less waviness, while having excellent tensile properties. A multilayer film which is obtained by superposing, on one surface of a layer B that contains a vinylidene fluoride resin, a layer A in a removable manner, said layer A being composed of a thermoplastic resin film that has a dimensional change rate of 5% or less in the MD direction and a dimensional change rate of 3% or less in the TD direction after being left at rest at 120° C. for 5 minutes as determined in accordance with JIS K7133 (1999). With respect to this multilayer film, the arithmetic mean height Sa₁ of a 4.8 mm×3.7 mm region of a surface of the layer B after separation of the layer A, said surface having been in contact with the layer A, is 80 nm or less as measured by means of a non-contact interferometric microscope in accordance with ISO 25178-604; and the nominal tensile strain at break is 100% or more at 25° C. in both the MD direction and the TD direction if a tensile test is performed on the layer B after separation of the layer A in accordance with JIS K7127 (1999) (test piece type 2).

### FIELD OF THE INVENTION

The present invention relates to a multilayer film comprising a layer containing a vinylidene fluoride-based resin and a method for producing the same. In particular, the present invention relates to a multilayer film comprising a layer containing a vinylidene fluoride-based resin, which is applicable to the field of automobile decoration, and a method for producing the same.

### BACKGROUND OF THE INVENTION

Vinylidene fluoride-based resins have been widely used as surface layer materials such as signboards used outdoors, wrapping films for mobility, and repair films in the infrastructure field, by taking advantage of their weatherability, chemical resistance, and antifouling property. In recent years, vinylidene fluoride-based resins have been used as surface layer materials of decorative films used for interiors or exteriors of automobiles, or members of electric appliances and the like, and research and development are progressing from various viewpoints.

Patent Literature 1 (Japanese Patent No. 5626555) describes an invention, the aim of which is to provide a fluorine-based resin multilayer film which can maintain the weatherability of the fluorine-based resin and has a good appearance in which the fluorine-based resin layer is not peeled off even when exposed to outdoors for a long time. Specifically, in the literature, there is disclosed a fluorine-based resin multilayer film in which a fluorine-based resin layer is laminated on an acrylic resin layer, wherein the fluorine-based resin forming the fluorine-based resin layer comprises 5 to 20% by mass of hexafluoropropylene units. The literature discloses that the fluorine-based resin layer contains polyvinylidene fluoride.

Patent Literature 2 (Japanese Patent No. 4580066) describes an invention, the aim of which is to provide a fluorine-based resin laminate and a formed body made of the same, particularly a fluorine-based resin laminate suitable for interior and exterior materials of vehicles such as automobiles and a formed body made of the same, in which adhesion to formed bodies made of other resins containing plasticizers is difficult to occur, and which has a surface layer with chemical resistance, does not easily generate cracks due to external force, does not easily generate fine wrinkles on the surface layer in a high temperature environment, and has heat resistance. In the literature, it is described that a laminate of a surface layer composed of a vinylidene fluoride-based resin and an acrylic-based resin in a specific ratio and a layer composed of an acrylic-based resin having specific physical properties is effective in achieving the above aim.

Specifically, Patent Literature 2 discloses a fluorine-based resin laminate having at least two layers arranged in order of a first layer and a second layer, wherein the first layer is a surface layer made of a resin composition of 30 to 70 parts by weight of a vinylidene fluoride-based resin and 30 to 70 parts by weight of an acrylic-based resin (the total of two being 100 parts by weight); and the second layer is composed of an acrylic-based resin with a breaking elongation of 20% or more according to ASTM D638 and a tan S peak value of 100 to 150° C. as determined from viscoelasticity measurement according to ASTM D5026. In the literature, there is also described a fluorine-based resin laminate having a decorative layer on the surface of the second layer which faces away from the first layer.

Patent Literature 3 (Japanese Patent Application Publication No. S62-138533) describes an invention, the aim of which is to provide a method for producing a polyvinylidene fluoride-based film having excellent transparency and good industrial productivity. The producing method comprises heating and dissolving both polymers of a vinylidene fluoride-based polymer and an acrylic-based polymer in a solvent capable of dissolving them to form a coating liquid; then, forming a film from this coating liquid with a casting method; and then, heating and drying the film.

According to Patent Literature 3, the casting method is a method in which a thin film is obtained by casting a polymer solution onto a flat and perfectly homogeneous substrate and then removing the solvent. Therefore, the resulting film has the advantage of having the most excellent uniformity of thickness, as well as the advantage of being excellent in both smoothness and gloss.

According to Patent Literature 3, the coating film (film) formed by casting is heat-dried to obtain the intended polyvinylidene fluoride-based film having excellent transparency, and at this time, the suitable heat drying temperature is 120° C. or higher, preferably 130 to 160° C. If the temperature is lower than 120° C., the resulting film will become cloudy, which is not preferred.

### PRIOR ART

### Patent Literature

[Patent Literature 1] Japanese Patent No. 5626555
[Patent Literature 2] Japanese Patent No. 4580066
[Patent Literature 3] Japanese Patent Application Publication No. S62-138533

### SUMMARY OF THE INVENTION

In recent years, new trends such as the shift to EVs and the spread of self-driving technology stand out in the automotive industry. Along with this, in order to express the concept of cars in the field of automobile decoration, there is a tendency for designs to become more diversified and complicated. Along with such trends in the field of automobile decoration, depending on the design of a decorative film, there have arisen cases where it is required to further reduce the undulation of the outermost surface of a surface layer material. For example, in metal-tone decorative films such as vapor-deposited films, if the outermost surface of the surface layer material has undulation, the surface image may appear distorted, so a surface layer material with less undulation on the outermost surface is desirable.

In this regard, although films containing a vinylidene fluoride-based resin have excellent properties such as weatherability, chemical resistance, and antifouling property as described above, it has a problem that it shrinks even at room temperature immediately after film formation, and the film tends to undulate due to non-uniform shrinkage. According to the invention described in Patent Literature 3, casting on a flat and perfectly homogeneous substrate yields a film with excellent smoothness and gloss, but the specific degree of smoothness is not discussed. In addition, films obtained by the casting method tend to have low tensile properties. For this reason, when a decorative film is produced using a film prepared by the casting method, there is a problem that the film is easily torn and broken when the film is stretched into the shape of an adherend. The reason for this is not definitely clear, but when the casting method is employed, the polymer must be dissolved in a solvent. It is thus considered that the physical properties of the polymer must be adjusted such that it can be easily dissolved in the solvent. Furthermore, it is also conceivable that the solvent remains in the film as an impurity and acts as a plasticizer.

The present invention has been created in view of the above circumstances, and in one embodiment, an object of the present invention is to provide a multilayer film comprising a layer containing a vinylidene fluoride-based resin which has excellent tensile properties with less undulation, and a method for producing the same.

The inventors of the present invention have conducted various studies to achieve the above problems, and as a result, it has been found that by laminating a layer containing a melt-extruded vinylidene fluoride-based resin in a peelable state on a thermoplastic resin film with less dimensional change after heating, the above object can be advantageously achieved. The inventors have then arrived at the present invention exemplified as below.
[1] A multilayer film, comprising a B layer which comprises a vinylidene fluoride-based resin, and an A layer laminated on a surface of the B layer in a peelable state, wherein the A layer is composed of a thermoplastic resin film having a dimensional change rate after being left to stand at 120° C. for 5 minutes of 5% or less in MD direction and 3% or less in TD direction measured according to JIS K7133: 1999; wherein an arithmetic mean height Sa₁ after peeling off the A layer measured with a non-contact interference microscope according to ISO25178-604 in an area of 4.8 mm×3.7 mm on a surface of the B layer that was in contact with the A layer is 80 nm or less; and wherein when a tensile test is performed according to JIS K7127: 1999 (specimen type 2) on the B layer after the A layer is peeled off, a nominal tensile strain at break at 25° C. is 100% or more in both the MD and TD directions.
[2] The multilayer film according to [1], wherein the arithmetic mean height Sa₁ after peeling off the A layer measured with the non-contact interference microscope according to ISO25178-604 in the area of 4.8 mm×3.7 mm on the surface of the B layer that was in contact with the A layer, and an arithmetic mean height Sa₂ after peeling off the A layer measured with a laser microscope according to ISO25178-607 in an area of 0.3 mm×0.3 mm on the surface of the B layer that was in contact with the A layer satisfy |Sa₁-Sa₂|≤30 nm.
[3] The multilayer film according to [1] or [2], wherein the B layer comprises a copolymer of vinylidene fluoride and hexafluoropropene; and/or polyvinylidene fluoride.
[4] The multilayer film according to any one of [1] to [3], wherein the B layer comprises the vinylidene fluoride-based resin which comprises a copolymer of vinylidene fluoride and hexafluoropropene, and/or polyvinylidene fluoride; and a methacrylic acid ester-based resin; and wherein with respect to a total of 100 parts by mass of the vinylidene fluoride-based resin and the methacrylic acid ester-based resin, the B layer comprises 51 parts by mass or more of the vinylidene fluoride-based resin and 49 parts by mass or less of the methacrylic acid ester-based resin.
[5] The multilayer film according to any one of [1] to [4], wherein the thickness of the B layer is 5 μm or more and 200 μm or less.
[6] The multilayer film according to any one of [1] to [5], wherein the thermoplastic resin comprised in the A layer is one or two or more selected from polyethylene terephthalate, polypropylene, and polyamide.
[7] The multilayer film according to any one of [1] to [6], wherein the A layer is a biaxially stretched film.
[8] The multilayer film according to any one of [1] to [7], wherein an arithmetic mean height Sa₃ after peeling off the A layer measured with the non-contact interference microscope according to ISO25178-604 in an area of 4.8 mm×3.7 mm on a surface of the A layer that was in contact with the B layer is 80 nm or less.
[9] The multilayer film according to any one of [1] to [8], wherein a surface of the A layer that is in contact with the B layer is coated with a silicone-based release agent.
[10] The multilayer film according to any one of [1] to [9], wherein a thickness of the A layer is 5 μm or more and 200 μm or less.
[11] The multilayer film according to any one of [1] to [10], wherein a C layer comprising a resin component which comprises at least a methacrylic acid ester-based resin is laminated on a surface of the B layer opposite to the surface on which the A layer is laminated; and wherein when a tensile test is performed according to JIS K7127: 1999 (specimen type 2) on a two-layer laminate composed of the B layer and the C layer after peeling off the A layer, a nominal tensile strain at break at 25° C. is 100% or more in both the MD and TD directions.
[12] The multilayer film according to [11], wherein the resin component of the C layer comprises a vinylidene fluoride-based resin.
[13] The multilayer film according to [11] or [12], wherein the C layer comprises a vinylidene fluoride-based resin which comprises a copolymer of vinylidene fluoride and hexafluoropropene and/or polyvinylidene fluoride; and a methacrylic acid ester-based resin; and wherein with respect to a total of 100 parts by mass of the vinylidene fluoride-based resin and the methacrylic acid ester-based resin, the C layer comprises 50 parts by mass or less of the vinylidene fluoride-based resin and 50 parts by mass or more of the methacrylic acid ester-based resin.
[14] The multilayer film according to any one of [11] to [13], wherein a thickness of the C layer is 5 μm or more and 200 μm or less.
[15] The multilayer film according to any one of claims [11] to [14], wherein the C layer comprises 0.1 to 10 parts by mass of an ultraviolet absorber based on a total of 100 parts by mass of all components in the C layer.
[16] The multilayer film according to [15], wherein the ultraviolet absorber is a triazine-based compound and/or a benzotriazole-based compound.
[17] A method for producing a multilayer film according to any one of [1] to [10], comprising:
   melt extrusion molding a raw material for forming the B layer from a T-die into a film; and
   sandwiching the film after the melt extrusion molding between a casting roll and the A layer on a touch roll to cool and solidify the film after the melt extrusion molding while laminating the A layer to the film after the melt extrusion molding in a peelable state.
[18] A method for producing a multilayer film according to any one of claims [11] to [16], comprising:
   melt coextrusion molding a raw material for forming the B-layer and a raw material for forming the C-layer from a T-die into a two-layer film composed of the B layer and the C layer;
   sandwiching the two-layer film after the melt coextrusion molding between a casting roll and the A layer on a touch roll such that the C layer is in contact with the casting roll to cool and solidify the two-layer film after the melt coextrusion molding while laminating the A layer to the B layer in a peelable state.

By peeling off the A layer from the multilayer film according to one embodiment of the present invention, a single layer body of the B layer comprising a vinylidene fluoride-based resin, or a two-layer laminate composed of the B layer and the C layer can be obtained. There are no particular restrictions on the use of the single body of the B layer or the two-layer laminate composed of the B layer and the C layer, but they have excellent tensile properties, and has a feature that the surface of the B layer that was in contact with the A layer has less undulation. The B layer or the two-layer laminate composed of the B layer and the C layer can be suitably used, for example, as a surface layer material for a decorative film, especially a metal-tone decorative film.

Further, in the multilayer film according to one embodiment of the present invention, the A layer can be used as a protective layer, and it is possible to prevent the surface of the B layer comprising the vinylidene fluoride-based resin from being damaged after producing the multilayer film and before peeling off the A layer in various processes (packaging, transportation, lamination of a decorative layer, attachment of a decorative film to an adherend, forming, and the like).

### BRIEF DESCRIPTION OF THE DRAWINGS

FIG. 1 is a schematic cross-sectional view showing a laminated structure of a multilayer film according to the first embodiment of the present invention.

FIG. 2 is a schematic side view for explaining an example of the multilayer film producing apparatus according to the first embodiment of the present invention.

FIG. 3 is a schematic cross-sectional view showing a laminated structure of a multilayer film according to the second embodiment of the invention.

### DETAILED DESCRIPTION OF THE INVENTION

Hereinafter, embodiments of the present invention will be described. The embodiments described below are illustrative of representative embodiments of the present invention, and are not intended to narrowly interpret the technical scope of the present invention.

### 1. First Embodiment

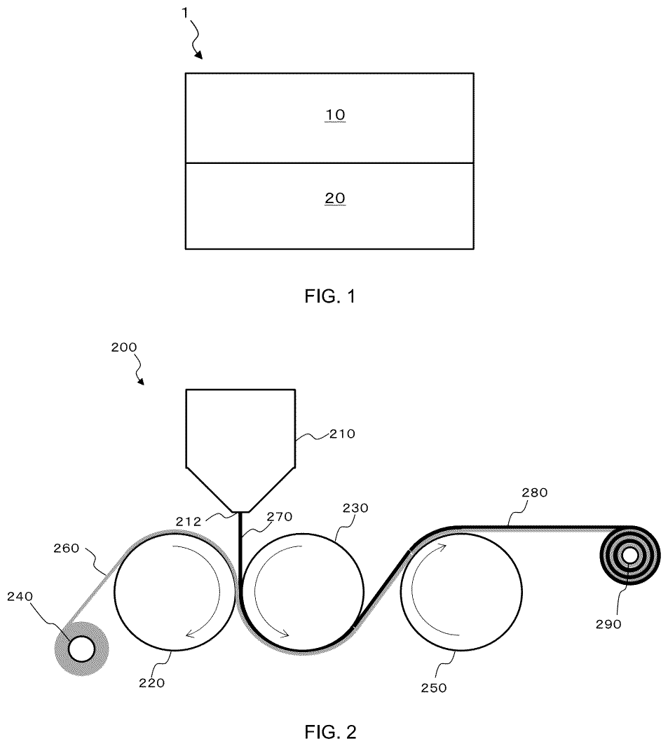

Referring to FIG. 1, the multilayer film (1) according to the first embodiment comprises a B layer (20) which comprises a vinylidene fluoride-based resin and an A layer (10) laminated on a surface of the B layer (20) in a peelable state. Since the A layer is laminated on the surface of the B layer in a peelable state, the A layer can be peeled off when necessary. For example, after the A layer is peeled off, the B layer can be used as the outermost layer of a surface layer material of a decorative film.

When a thermoplastic resin film having excellent dimensional stability is used as the A layer, even if the B layer comprising the vinylidene fluoride-based resin is likely to cause dimensional change, the A layer acts as a resistance to dimensional change because the B layer is laminated on the A layer, and the dimensional change of the B layer is suppressed. As a result, it is possible to reduce the occurrence of undulation, which is a weak point of films containing the vinylidene fluoride-based resin.

In the multilayer film according to one embodiment of the present invention, the A layer can be composed of a thermoplastic resin film having a dimensional change rate after being left to stand at 120° C. for 5 minutes of 5% or less in MD direction and 3% or less in TD direction measured according to JIS K7133: 1999. Preferably, the A layer can be composed of a thermoplastic resin film having the dimensional change rate of 3% or less in the MD direction and 2% or less in the TD direction. Although the lower limit of the dimensional change rate of the A layer is not particularly set, it can be composed of a thermoplastic resin film having the dimensional change rate of 1 to 5% in the MD direction and 0.5 to 3% in the TD direction, for example. Note that the MD direction is the flow direction of a resin base material when producing the thermoplastic resin film constituting the A layer, and the TD direction is the direction perpendicular to the flow direction of the resin base material.

As the thermoplastic resin contained in the A layer, it is not limited, but may be one or two or more selected from polyethylene terephthalate, polypropylene, and polyamide. These thermoplastic resins have a small dimensional change rate, and since resin films satisfying the above-mentioned dimensional change rate are commercially available, they are also readily available, which is convenient. Among thermoplastic resins, one or two selected from polyethylene terephthalate and polyamide are particularly preferable for the reason of heat resistance (melting point).

The thermoplastic resin film forming the A layer is preferably a biaxially stretched film. By using a biaxially stretched film, the advantages of being hard to break and having a small dimensional change rate with respect to heat can be obtained.

The thickness of the A layer is preferably 5 to 200 μm, more preferably 5 to 100 μm, even more preferably 5 to 40 μm, particularly preferably 10 to 20 μm. It is preferable that the thickness of the A layer be 5 μm or more from the viewpoint of handling ability and prevention of damage to the B layer. Further, the fact that the thickness of the A layer is 200 μm or less contributes to cost reduction.

The peel strength between the A layer and the B layer is preferably higher from the viewpoint of preventing unintended peeling due to their own weight and from the viewpoint of enhancing the effect of suppressing the dimensional change of the B layer. From this point of view, the peel strength between the A layer and the B layer is preferably 0.01 N/25 mm or more, and preferably 0.05 N/25 mm or more, and even more preferably 0.1 N/25 mm or more, as the average peel force when a 180° peel test is performed. In addition, if the peel strength between the A layer and the B layer is too high, the usability deteriorates, and the B layer may be deformed during peeling. Therefore, the peel strength between the A layer and the B layer is preferably 40 N/25 mm or less, and preferably 25 N/25 mm or less, even more preferably 12.5 N/25 mm or less, and most preferably 2.5 N/25 mm or less, as the average peel force when a 180° peel test is performed. Accordingly, in a preferred embodiment, the peel strength between the A layer and the B layer is 0.01 N/25 mm or more and 40 N/25 mm or less as the average peel force when a 180° peel test is performed.

The above 180° peel test is performed in the following procedure. First, the B layer side (when the multilayer film comprises a C layer, which will be described later, the C layer side) of the multilayer film sample is fixed to a SUS plate with a strong double-sided tape. The A layer is partially peeled off from the multilayer film sample. Next, the SUS plate and the A layer are each chucked, and a 180° peel test is performed under the conditions of temperature: 23° C., relative humidity: 50%, sample size: length 150 mm×width 25 mm, grip movement speed: 300 mm/min, and average peel force is obtained. Other conditions are in accordance with JIS K6854-2: 1999. Five or more samples are prepared, and the arithmetic mean of the average peel force is used as the measured value.

In order to adjust the peel strength between the A layer and the B layer, the side of the A layer that contacts the B layer may be coated with a release agent such as a silicone-based release agent. Examples of the silicone-based release agent include known silicone-based release agents such as addition reaction type, condensation reaction type, cationic polymerization type, and radical polymerization type release agents.

After peeling off the A layer, the surface of the B layer that was in contact with the A layer preferably has a small undulation. If the undulation of the surface of the B layer is small, distortion of a surface image can be suppressed, for example, when the B layer is used as the outermost layer of a surface layer material of a metal-tone decorative film. In order to evaluate surface undulation, it is effective to measure surface roughness over a relatively large area.

In the multilayer film according to one embodiment of the present invention, an arithmetic mean height Sa₁ after peeling off the A layer measured with a non-contact interference microscope according to ISO25178-604 in an area of 4.8 mm×3.7 mm on the surface of the B layer that was in contact with the A layer can be 80 nm or less. The arithmetic mean height Sa₁ is preferably 60 nm or less, more preferably 40 nm or less, still more preferably 20 nm or less. Although no particular lower limit is set for the arithmetic mean height Sa₁, the arithmetic mean height Sa₁ is preferably 5 nm or more, and more preferably 10 nm or more, in view of the balance between the producing cost and the effect of suppressing undulation. Therefore, the arithmetic mean height Sa₁ can be in the range of 5 to 80 nm, for example. In the multilayer film according to one embodiment of the present invention, after peeling off the A layer, at any measurement area on the surface of the B layer that was in contact with the A layer, the criterion regarding the arithmetic mean height Sa₁ may be satisfied.

The surface undulation can also be evaluated by comparing the surface roughness of a relatively large area with the surface roughness of a relatively small area. Since surface roughness in a relatively small area does not easily reflect surface undulation, the difference between the two surface roughness values tends to increase when the surface undulation is large.

In the multilayer film according to one embodiment of the present invention, the arithmetic mean height Sa₁ after peeling off the A layer measured with a non-contact interference microscope according to ISO25178-604 in an area of 4.8 mm×3.7 mm on a surface of the B layer that was in contact with the A layer, and an arithmetic mean height Sa₂ after peeling off the A layer measured with a laser microscope according to ISO25178-607 in an area of 0.3 mm×0.3 mm on the surface of the B layer that was in contact with the A layer can satisfy |Sa₁-Sa₂|≤30 nm. |Sa₁-Sa₂| is preferably 20 nm or less, more preferably 10 nm or less. In addition, normally Sa₁≥Sa₂. In the multilayer film according to one embodiment of the present invention, after peeling off the A layer, at any measurement area on the surface of the B layer that was in contact with the A layer, the criterion regarding |Sa₁-Sa₂| may be satisfied.

The surface roughness of the surface of the B layer that was in contact with the A layer is easily affected by the surface roughness of the surface of the A layer that was in contact with the B layer. Therefore, it is preferable that the surface roughness of the A layer be small. In the multilayer film according to one embodiment of the present invention, an arithmetic mean height Sa₃ after peeling off the A layer measured with a non-contact interference microscope according to ISO25178-604 in an area of 4.8 mm×3.7 mm on a surface of the A layer that was in contact with the B layer can be 80 nm or less. The arithmetic mean height Sa₃ is preferably 60 nm or less, more preferably 50 nm or less, and even more preferably 40 nm or less. Although no particular lower limit is set for the arithmetic mean height Sa₃, the arithmetic mean height Sa₃ is preferably 1 nm or more, more preferably 5 nm or more, in view of the balance between the producing cost and the effect of suppressing undulation. Therefore, the arithmetic mean height Sa₃ can be in the range of 1 to 80 nm, for example. In the multilayer film according to one embodiment of the present invention, after peeling off the A layer, at any measurement area on the surface of the A layer that was in contact with the B layer, the criterion regarding the arithmetic mean height Sa₃ may be satisfied.

Further, in the multilayer film according to one embodiment of the present invention, an arithmetic mean height Sa₄ measured with a laser microscope according to ISO25178-607 in an area of 0.3 mm×0.3 mm on the same surface of the A layer can be 80 nm or less. The arithmetic mean height Sa₄ is preferably 60 nm or less, more preferably 40 nm or less, and even more preferably 20 nm or less. Although no particular lower limit is set for the arithmetic mean height Sa₄, the arithmetic mean height Sa₄ is preferably 1 nm or more, and more preferably 5 nm or more, in view of the balance between the producing cost and the effect of suppressing undulation. Therefore, the arithmetic mean height Sa₄ can be in the range of 1 to 80 nm, for example. In the multilayer film according to one embodiment of the present invention, at any measurement area on the surface of the A layer that was in contact with the B layer, the criterion regarding the arithmetic mean height Sa₄ may be satisfied.

After peeling off the A layer, it is desirable that the B layer (when the multilayer film comprises a C layer, which will be described later, the two-layer laminate of the B layer and the C layer) has excellent tensile properties. This is because it becomes difficult to break even if stretching is performed. In the process of attaching a decorative film to an adherend, the film is often stretched into the shape of the adherend. Therefore, it is convenient for application to a decorative film if the B layer after peeling off the A layer has excellent tensile properties.

In the multilayer film according to one embodiment of the present invention, when a tensile test is performed according to JIS K7127: 1999 (specimen type 2) on the B layer after the A layer is peeled off, a nominal tensile strain at break at 25° C. can be 100% or more in both the MD and TD directions. The nominal tensile strain at break is preferably 200% or more, more preferably 300% or more, and even more preferably 400% or more in both the MD and TD directions. Although no particular upper limit is set for the nominal tensile strain at break, it is preferably 700% or less, and more preferably 600% or less, from the viewpoint of ease of manufacture. In addition, the nominal tensile strain at break herein refers to the nominal strain immediately before the stress decreases to 10% or less of the tensile strength in the case of fracture after yielding, as defined in JIS K7161-1:2014. Five or more samples are prepared in both the MD direction and the TD direction, and the arithmetic mean of the nominal tensile strain at break for the five or more samples is taken as the measured value.

In the multilayer film according to one embodiment of the present invention, for the B layer after the A layer is peeled off, the Elmendorf tear resistance according to JIS K7128-2: 1998 (rectangular test piece) can be 7000 N/m or more with the tearing direction in the MD direction, and can be 9000 N/m or more with the tearing direction in the TD direction. The Elmendorf tear resistance is preferably 8000 N/m or more in the VID direction, and more preferably 10000 N/m or more in the TD direction. Although no particular upper limit is set for the Elmendorf tear resistance, it is preferably 14000 N/m or less, more preferably 13000 N/m or less in both the MD and TD directions from the viewpoint of ease of production. Five or more samples are prepared for both the MD direction and the TD direction, and the arithmetic mean of the Elmendorf tear resistance of the five or more samples is taken as the measured value.

The HAZE of the B layer measured according to JIS K7136: 2000 is preferably 20% or less, more preferably 10% or less, even more preferably 5% or less, most preferably 2% or less, and can be, for example, in the range of 0.1 to 20%, from the viewpoint of increasing transparency. However, from the viewpoint of design, these ranges do not necessarily apply when a matting agent such as crosslinked acryl fine particles, silica particles, or polysiloxane particles is added to intentionally increase the HAZE.

The total light transmittance of the B layer measured according to JIS K7375: 2008 is preferably 80% or more, more preferably 85% or more, even more preferably 90% or more, and can be, for example, 80 to 95%, from the viewpoint of increasing transparency.

The thickness of the B layer is preferably 5 to 200 μm, more preferably 5 to 100 μm, even more preferably 5 to 40 μm, particularly preferably 10 to 20 μm. When the thickness of the B layer is 5 μm or more, the film formability is improved, and the protection function when the B layer is used as a surface layer material of a decorative film can be improved. In addition, by setting the thickness of the B layer to 200 μm or less, it is possible to improve the transparency and reduce the cost.

The B layer comprises a vinylidene fluoride-based resin. In the present specification, the vinylidene fluoride-based resin refers to homopolymers of vinylidene fluoride, as well as copolymers of vinylidene fluoride and monomers copolymerizable with the vinylidene fluoride. As monomers copolymerizable with vinylidene fluoride, for example, there are known vinyl monomers such as vinyl fluoride, tetrafluoroethylene, hexafluoropropylene (hexafluoropropene), hexafluoroisobutylene, chlorotrifluoroethylene, various fluorinated alkyl vinyl ethers, as well as styrene, ethylene, butadiene, and propylene. These can be used alone or in combination of two or more types. Among these, at least one selected from vinyl fluoride, tetrafluoroethylene, hexafluoropropylene (hexafluoropropene) and chlorotrifluoroethylene is preferred, and hexafluoropropylene (hexafluoropropene) is more preferred. Therefore, in a preferred embodiment, the B layer comprises a copolymer of vinylidene fluoride and hexafluoropropylene (hexafluoropropene), and/or polyvinylidene fluoride.

The B layer preferably comprises a methacrylic acid ester-based resin in addition to the vinylidene fluoride-based resin. By containing a methacrylic acid ester-based resin in the B layer, it is possible to prevent the ratio of α-type crystals, which promotes white turbidity, from increasing, and to adjust the adhesiveness and adhesion when laminating another layer on the B layer.

In one embodiment, the mixing ratio of the vinylidene fluoride-based resin and the methacrylic acid ester-based resin in the B layer can be 51 parts by mass or more of the vinylidene fluoride-based resin, and 49 parts by mass or less of the methacrylic acid ester-based resin, with respect to a total of 100 parts by mass of the two. With respect to a total of 100 parts by mass of the two, it is preferable that vinylidene fluoride-based resin: methacrylic acid ester-based resin=51 to 80 parts by mass: 20 to 49 parts by mass, and 60 to 75 parts by mass: 25 to 40 parts by mass is more preferable. When the vinylidene fluoride-based resin is 51 parts by mass or more with respect to the total of 100 parts by mass of the vinylidene fluoride-based resin and the methacrylic acid ester-based resin, tensile elongation, tear resistance, chemical resistance, weatherability and antifouling property and the like can be improved.

In addition to the vinylidene fluoride-based resin and the methacrylic acid ester-based resin, the B layer may comprise other resins, plasticizers, heat stabilizers, antioxidants, light stabilizers, crystal nucleating agents, anti-blocking agents, sealing improvers, release agents, colorants, pigments, blowing agents, flame retardants, and others, as long as they do not impair the purpose of the present invention. However, generally, the total content of the vinylidene fluoride-based resin and the methacrylic acid ester-based resin in the B layer is 80% by mass or more, typically 90% by mass or more, more typically 95% by mass or more, and can be 100% by mass. Although the B layer may contain an ultraviolet absorber, it is preferable not to contain it from the viewpoint of cost and bleed-out.

Polymerization reactions for obtaining vinylidene fluoride-based resins include known polymerization reactions such as radical polymerization and anionic polymerization. Further, the polymerization method includes known polymerization methods such as suspension polymerization and emulsion polymerization. The degree of crystallinity, mechanical property, and the like of the obtained resin can be changed by the polymerization reaction and/or the polymerization method.

The lower limit of the melting point of the vinylidene fluoride-based resin is preferably 150° C. or higher, and more preferably 160° C. or higher. The upper limit of the melting point of the vinylidene fluoride-based resin is preferably 170° C. (which is equal to the melting point of polyvinylidene fluoride (PVDF)) or lower.

The lower limit of the glass transition temperature (Tg) of the methacrylic acid ester-based resin is preferably 70° C. or higher, more preferably 80° C. or higher. The upper limit of the Tg of the methacrylic acid ester-based resin is preferably 120° C. or lower.

The melting point of the vinylidene fluoride-based resin and the Tg of the methacrylic acid ester-based resin can be measured by heat flux differential scanning calorimetry (heat flux DSC). For example, it can be measured from a DSC curve (first run) by heating a sample mass of 1.5 mg from room temperature to 200° C. at a heating rate of 10° C./min using a differential scanning calorimeter DSC3100SA produced by Bruker AXS.

In the present specification, the methacrylic acid ester-based resin refers to a homopolymer of a methacrylic acid ester such as methyl methacrylate, and a copolymer of a methacrylic acid ester and a monomer copolymerizable with the methacrylic acid ester. As monomers that can be copolymerized with methacrylic acid ester, there are (meth)acrylic acid esters such as butyl acrylate, butyl methacrylate, ethyl acrylate and ethyl methacrylate; aromatic vinyl monomers such as styrene, α-methylstyrene, p-methylstyrene, o-methylstyrene, t-butylstyrene, divinylbenzene, tristyrene; vinyl cyanide monomers such as acrylonitrile and methacrylonitrile; glycidyl group-containing monomers such as glycidyl (meth)acrylate; vinyl carboxylate-based monomers such as vinyl acetate and vinyl butyrate; olefin-based monomers such as ethylene, propylene and isobutylene; diene monomers such as 1,3-butadiene, isoprene; unsaturated carboxylic acid monomers such as maleic acid, maleic anhydride, (meth)acrylic acid; and enone-based monomers such as vinyl methyl ketone. These can be used alone or in combination of two or more types. Among these, from the view point of compatibility with vinylidene fluoride-based resin, film strength, and adhesiveness and adhesion with another layer, a homopolymer of methyl methacrylate, or an acrylic rubber-modified acrylic copolymer obtained by copolymerizing an acrylic rubber mainly composed of butyl methacrylate with a monomer mainly composed of methyl (meth)acrylate is preferable.

As copolymers, mention can be made to random copolymers, graft copolymers, block copolymers (for example, linear types such as diblock copolymers, triblock copolymers, and gradient copolymers, and star copolymers polymerized by an arm-first method or a core-first method, and the like), copolymers obtained by polymerization using macromonomers, which are polymer compounds with polymerizable functional groups (macromonomer copolymers), and mixtures thereof. Among them, graft copolymers and block copolymers are preferable from the viewpoint of resin productivity.

Polymerization reactions for obtaining the methacrylic acid ester-based resin include known polymerization reactions such as radical polymerization, living radical polymerization, living anion polymerization, and living cationic polymerization. Moreover, the polymerization method includes known polymerization methods such as bulk polymerization, suspension polymerization, emulsion polymerization, and solution polymerization. Polymerization reactions and polymerization methods change the mechanical properties of the resulting resin.

The multilayer film according to the first embodiment can be produced by, for example, performing the following steps:
step 1: melt extrusion molding a raw material for forming the B layer from a T-die into a film; and
step 2: sandwiching the film after the melt extrusion molding between a casting roll and a film for the A layer on a touch roll to cool and solidify the film after the melt extrusion molding while laminating the A layer to the film after the melt extrusion molding in a peelable state.

According to the producing process described above, the surface properties of the surface of the B layer that contacts the A layer is dependent on the surface properties of the A layer. Therefore, it is desirable that the A layer be smooth and have little undulation. In order to better transfer the smooth surface properties of the A layer with less undulation to the surface of the B layer, it is desirable that the initial temperature is high when the film for the B layer after the melt extrusion molding contacts the A layer. Specifically, it is preferable to extrude into a film from a T-die of an extruder at a temperature of 200° C. or higher, for example, a temperature of 200 to 260° C. Extruding at a temperature within this range is also advantageous from the viewpoint of reducing the ratio of α-type crystals. After the film for the B layer is extruded from the exit of the T-die, it is desirable to bring the film for the B layer into contact with the A layer within 6 seconds, preferably within 4 seconds.

For the purpose that the A layer and the B layer can be laminated with appropriate adhesion, the temperature of the casting roll is preferably controlled to 30 to 70° C., preferably 40 to 60° C., and the temperature of the touch roll is preferably controlled to 30 to 70° C., preferably 40 to 60° C. The method for adjusting the temperature of the surface of the casting roll and the touch roll is not limited, but for example, a method of circulating a cooling medium such as cooling water inside these rolls can be mentioned. The surface materials of the casting roll and the touch roll are not particularly limited, but for example, the surface of the casting roll can be made of metal and the surface of the touch roll can be made of rubber.

FIG. 2 shows a schematic side view for explaining an example of a producing apparatus (200) for the multilayer film according to the first embodiment of the present invention. The producing apparatus (200) comprises a T-die (210) for extruding a film (270) for the B layer, a touch roll (220) and a casting roll (230) disposed below the exit (212) of the T-die (210), a reel (240) for feeding a film (260) for the A layer to the touch roll (220), a cooling roll (250) disposed beside the casting roll (230), and a reel (290) for winding the multilayer film (280). Although not shown, an extruder such as a twin-screw extruder is arranged above the T-die (210).

The film (270) for the B layer extruded downward from the T-die (210) is sandwiched between the casting roll (230) and the film (260) for the A layer on the touch roll (220). At this time, the B layer film (270) is cooled and solidified while the film (260) for the A layer is laminated on the film (270) for the B layer in a peelable state. After moving along the rotation direction of the casting roll (230), the multilayer film (280) thus obtained is cooled by being conveyed on the cooling roll (250), and finally wound up on the reel (290).

As described above, a film containing the vinylidene fluoride-based resin tends to undulate. For this reason, if the film for the B layer comprising the vinylidene fluoride-based resin is wound up alone without being laminated on the A layer, undulation occurs during transportation and after winding. On the other hand, according to the above-described producing method, the film for the B layer is wound as a multilayer film in a state in which it is laminated on the film for the A layer, which has high dimensional stability, so that the undulation of the B layer is reduced.

### 2. Second Embodiment

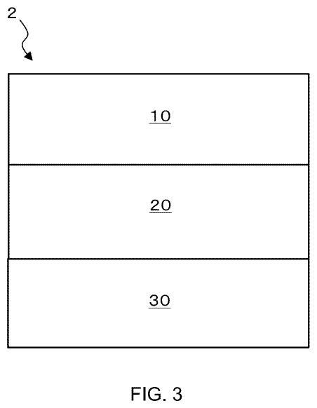

Referring to FIG. 3, the multilayer film (2) according to the second embodiment comprises a B layer (20) which comprises a vinylidene fluoride-based resin, and an A layer (10) composed of a thermoplastic resin film laminated on a surface of the B layer (20) in a peelable state. The multilayer film (2) further comprises a C layer (30) which comprises a resin component containing at least a methacrylic acid ester-based resin, and the C layer (30) is laminated on the surface of the B layer (20) opposite to the surface on which the A layer (10) is laminated. Typically, the B layer (20) and the C layer (30) are directly bonded without any other resin layer interposed therebetween.

The multilayer film (2) according to the second embodiment differs from the multilayer film (1) according to the first embodiment only in the presence or absence of the C layer (30), and the embodiment regarding the A layer and the B layer, as well as the preferred conditions, are as described in the multilayer film (1) according to the first embodiment. Therefore, detailed description of the A layer and the B layer is omitted.

The peel strength between the A layer and the B layer is as described for the multilayer film (1) according to the first embodiment. The peel strength between the B layer and the C layer is normally greater than the peel strength between the B layer and the A layer when comparing the average peel force when the above-mentioned 180° peel test is performed. It is contemplated that the B layer and the C layer will not be peeled off and will be used as a laminate. Also, in the multilayer film (2) according to the second embodiment, the A layer is laminated on the surface of the B layer in a peelable state, so that the A layer can be peeled off when necessary. For example, after the A layer is peeled off, a two-layer laminate composed of the B layer and the C layer can be used as a surface layer material of a decorative film. Also in this case, the B layer can be used as a layer constituting the outermost surface of the surface layer material of the decorative film.

In the multilayer film according to one embodiment of the present invention, when a tensile test is performed according to JIS K7127: 1999 (specimen type 2) on the two-layer laminate composed of the B layer and the C layer after the A layer is peeled off, a nominal tensile strain at break at 25° C. can be 100% or more in both the MD and TD directions. The nominal tensile strain at break is preferably 200% or more, more preferably 300% or more, and even more preferably 400% or more in both the VID and TD directions.

In the multilayer film according to one embodiment of the present invention, for the two-layer laminate composed of the B layer and the C layer after the A layer is peeled off, the Elmendorf tear resistance according to JIS K7128-2: 1998 (rectangular test piece) can be 7000 N/m or more with the tearing direction in the MD direction, and can be 9000 N/m or more with the tearing direction in the TD direction. The Elmendorf tear resistance is preferably 8000 N/m or more in the MD direction, and more preferably 10000 N/m or more in the TD direction. Although no particular upper limit is set for the Elmendorf tear resistance, it is preferably 14000 N/m or less, more preferably 13000 N/m or less in both the MD and TD directions from the viewpoint of ease of production.

The HAZE of two-layer laminate composed of the B layer and the C layer measured according to JIS K7136: 2000 is preferably 20% or less, more preferably 10% or less, even more preferably 5% or less, most preferably 2% or less, and can be, for example, in the range of 0.1 to 20%, from the viewpoint of increasing transparency. However, from the viewpoint of design, these ranges do not necessarily apply when a matting agent such as crosslinked acryl fine particles, silica particles, or polysiloxane particles is added to intentionally increase the HAZE.

The total light transmittance of the two-layer laminate composed of the B layer and the C layer measured according to JIS K7375: 2008 is preferably 80% or more, more preferably 85% or more, even more preferably 90% or more, and can be, for example, 80 to 95%, from the viewpoint of increasing transparency.

The thickness of the C layer is preferably 5 to 200 μm, more preferably 5 to 100 μm, even more preferably 5 to 40 μm, particularly preferably 10 to 30 μm. When the thickness of the C layer is 5 μm or more, the film formability is improved, and the protection function when the two-layer laminate composed of the B layer and the C layer is used as a surface layer material of a decorative film can be improved. In addition, by setting the thickness of the C layer to 200 μm or less, it is possible to improve the transparency and reduce the cost.

The resin component constituting the C layer comprises at least a methacrylic acid ester-based resin. Embodiments of the methacrylic acid ester-based resin, as well as the preferred conditions, are as described in the description of the B layer, so detailed description herein will be omitted. Moreover, it is preferable that the resin component constituting the C layer comprise a vinylidene fluoride-based resin in addition to the methacrylic acid ester-based resin. Embodiments of the vinylidene fluoride-based resin, as well as the preferred conditions, are as described in the description of the B layer, so detailed description herein will be omitted. Therefore, in a preferred embodiment, the C layer contains a copolymer of vinylidene fluoride and hexafluoropropylene (hexafluoropropene), and/or polyvinylidene fluoride as the vinylidene fluoride-based resin.

In one embodiment, the mixing ratio of the vinylidene fluoride-based resin and the methacrylic acid ester-based resin in the C layer can be 50 parts by mass or less of the vinylidene fluoride-based resin and 50 parts by mass or more of the methacrylic acid ester-based resin with respect to a total of 100 parts by mass of the two. With respect to a total of 100 parts by mass of the two, it is preferable that vinylidene fluoride-based resin: methacrylic acid ester-based resin=0 to 30 parts by mass: 70 to 100 parts by mass, and 20 to 30 parts by mass: 70 to 80 parts by mass is more preferable. When the vinylidene fluoride-based resin is 70 parts by mass or more with respect to the total of 100 parts by mass of the vinylidene fluoride-based resin and the methacrylic acid ester-based resin, the adhesion with other layers such as a decorative layer, which will be described later, is improved. In addition, by containing a small amount of vinylidene fluoride-based resin in the C layer, it is possible to improve the weatherability, adhesiveness and adhesion with the B layer, and it is also possible to suppress deterioration of properties such as tensile elongation, tear resistance, chemical resistance, weatherability and antifouling property.

In addition to the vinylidene fluoride-based resin and the methacrylic acid ester-based resin, the C layer may comprise ultraviolet absorbers, other resins, plasticizers, heat stabilizers, antioxidants, light stabilizers, crystal nucleating agents, anti-blocking agents, sealing improvers, release agents, colorants, pigments, blowing agents, flame retardants, and others, as long as they do not impair the purpose of the present invention. However, generally, the total content of the vinylidene fluoride-based resin and the methacrylic acid ester-based resin in the C layer is 80% by mass or more, typically 90% by mass or more, more typically 95% by mass or more, and can be 100% by mass.

The C layer preferably comprises an ultraviolet absorber. By comprising an ultraviolet absorber in the C layer, ultraviolet rays are blocked and the weatherability can be effectively improved. Ultraviolet absorbers include, but are not limited to, hydroquinone-based, triazine-based, benzotriazole-based, benzophenone-based, cyanoacrylate-based, oxalic acid-based, hindered amine-based, salicylic acid derivatives, and the like. These can be used alone or in combination of two or more types. Among them, it is preferable to contain a triazine-based compound, a benzotriazole-based compound, or a mixture thereof from the viewpoint of durability of the ultraviolet absorption effect.

The content of the ultraviolet absorber in the C layer is preferably 0.1 to 10 parts by mass in the total of 100 parts by mass of all components in the C layer. By setting the content of the ultraviolet absorber to 0.1 parts by mass or more, preferably 1 part by mass or more, and more preferably 2 parts by mass or more in the total of 100 parts by mass of all components in the C layer, the effect of further improving the weatherability and the ultraviolet absorption effect can be expected. In addition, by setting the content of the ultraviolet absorber to 10 parts by mass or less, more preferably 5 parts by mass or less in the total of 100 parts by mass of all components in the C layer, the ultraviolet absorber is prevented from bleeding out, and it is possible to prevent deterioration of adhesion with the B layer and contribute to cost reduction.

A laminate in which the B layer and the C layer are laminated can be produced, for example, by a melt coextrusion molding method in which a plurality of resins is adhered and laminated in a molten state using a plurality of extruders. For the melt coextrusion method, there are a multi-manifold die method in which, after multiple resins are widened into a film shape, each layer is brought in contact and adhered at the tip inside the T-die, a feed block die method in which multiple resins are widened into a film shape after they are brought into contact in a confluence device (feed block), and a dual-slot die method in which, after multiple resins are widened into a film shape, and each layer is brought into contact and adhered at the tip outside the T-die. It can also be produced by an inflation molding method using a round die.

The multilayer film according to the second embodiment can be produced by, for example, performing the following steps:
step 1: melt coextrusion molding a raw material for forming the B-layer and a raw material for forming the C layer from a T-die into a two-layer film composed of the B layer and the C layer;
step 2: sandwiching the two-layer film after the melt coextrusion molding between a casting roll and the A layer on a touch roll such that the C layer is in contact with the casting roll to cool and solidify the two-layer film after the melt coextrusion molding while laminating the A layer to the B layer in a peelable state.

According to the producing process described above, the surface properties of the surface of the B layer that contacts the A layer is dependent on the surface properties of the A layer. Therefore, it is desirable that the A layer be smooth and have less undulation. In addition, in order to better transfer the smooth surface properties of the A layer with less undulation to the surface of the B layer, it is desirable that the initial temperature is high when the B layer of the two-layer film after the melt coextrusion molding contacts the A layer. Specifically, it is preferable to extrude a two-layer film from a T-die of an extruder at a temperature of 200° C. or higher, for example, a temperature of 200 to 260° C. Extruding at a temperature within this range is also advantageous from the viewpoint of reducing the ratio of α-type crystals. After the two-layer film is extruded from the exit of the T-die, it is desirable to bring the B layer of the two-layer film into contact with the A layer within 6 seconds, preferably within 4 seconds.

As to the casting roll and the touch roll, for the purpose that the A layer and the B layer can be laminated with appropriate adhesion, the temperature of the casting roll is preferably controlled to 30 to 70° C., preferably 40 to 60° C., and the temperature of the touch roll is preferably controlled to 30 to 70° C., preferably 40 to 60° C. The method for adjusting the temperature of the surface of the casting roll and the touch roll is not limited, but for example, a method of circulating a cooling medium such as cooling water inside these rolls can be mentioned. The surface materials of the casting roll and the touch roll are not particularly limited, but for example, the surface of the casting roll can be made of metal and the surface of the touch roll can be made of rubber.

### 3. Multilayer Film Laminated with Substrate

A substrate may be laminated on the multilayer film according to the first embodiment and the second embodiment. Accordingly, in one embodiment, the present invention provides a multilayer film in which a substrate is laminated on the surface, on which the A layer is not laminated, of the B layer of the multilayer film according to the first embodiment. In another embodiment of the present invention, there is provided a multilayer film in which a substrate is laminated on the surface, on which the B layer is not laminated, of the C layer of the resin film according to the second embodiment. The multilayer film laminated with the substrate can be used as, for example, a decorative film. When the average value of the total thickness of the multilayer film laminated with the substrate is 50 to 1000 μm, it is preferable from the viewpoint of the workability of adhering to automobile interior components and cost.

Examples of the substrate include layers such as a decorative layer (including a metal deposition layer), a protective layer, an adhesive layer, and a printed layer. One substrate may be used as a single layer, or a combination of two or more substrates may be used as a laminate. In a typical embodiment, a multilayer film is provided in which a metal deposition layer is laminated on the surface, on which the A layer is not laminated, of the B layer of the multilayer film according to the first embodiment, or on the surface, on which the B layer is not laminated, of the C layer of the multilayer film according to the second embodiment. In addition, in another typical embodiment, a resin film is provided in which a printed layer is formed on the surface, on which the A layer is not laminated, of the B layer of the multilayer film according to the first embodiment, or on the surface, on which the B layer is not laminated, of the C layer of the multilayer film according to the second embodiment, and another substrate (a decorative layer or the like) is laminated on the printed layer. For the decorative layer, in addition to a metal deposition layer, acryl-based resin, polycarbonate resin, polyvinyl chloride-based resin, polyester-based resin, or a resin composition containing these resins can be used. Additives such as pigments can also be added to the decorative layer as appropriate.

Further, the multilayer film according to the first embodiment and the second embodiment can be multi-layered with, other than the decorative layer, films such as isotactic or syndiotactic polypropylene, high-density polyethylene, low-density polyethylene, polystyrene, polyethylene terephthalate, and ethylene-vinyl acetate copolymer (EVA). Various decorative treatments, such as embossing, can also be performed.

Examples of methods for laminating a substrate on the multilayer film according to the first embodiment and the second embodiment include adhesive lamination and thermal lamination. Other known lamination methods can also be employed. Also, the multilayer film according to the first embodiment and the second embodiment can be used for thermoforming. As a method of thermoforming, for example, a method of laminating a substrate on a multilayer film, followed by vacuum forming, pressure forming, and vacuum pressure forming can be mentioned.

Techniques for coating the surface of articles such as automobile interior components with a decorative film include, for example, film insert molding, in-mold molding, and vacuum lamination molding (including vacuum and pressure molding such as TOM molding). Among them, film insert molding, which heats the decorative film for preforming, has an advantage that the decorative film can follow components with more complicated shapes and a better surface covering state can be realized, when compared to in-mold molding and vacuum lamination molding. The decorative film can be used with the A layer peeled off. The timing of peeling off the A layer is not particularly limited, but for example, from the viewpoint of protecting the B layer, it is desirable to peel off the A layer after the article is surface-coated with the decorative film.

### EXAMPLES

Hereinafter, the present invention will be described in detail based on Examples while comparing with Comparative Examples. Films according to the following Examples and Comparative Examples were prepared by either producing method I (melt extrusion molding+cooling and solidification with roll) or producing method II (casting method).

### 1. Preparation of Multilayer Films According to Examples 1 to 4 (Producing Method I)

### 1-1. Materials

<For A layer>

A smooth biaxially stretched film made of polyethylene terephthalate (PET) (trade name T60 produced by Toray Industries, Inc.) was prepared. The thickness of the film was measured at arbitrary five locations in the TD direction with a dial sheet gauge, and the average value was taken as the measured value. The result is shown in Table 1.

### <For B Layer>

As a vinylidene fluoride-based resin (PVDF), Kynar 1000HD (a PVDF homopolymer having a melting point of 168° C.) produced by Arkema was prepared.

As a methacrylic acid ester-based resin (PMMA), SUMIPEX MGSS (Tg 101° C. polymethyl methacrylate) produced by Sumitomo Chemical Co., Ltd. was prepared.

### <For C Layer>

C layer was not used.

### 1-2. Preparation of Multilayer Film

According to the test number, each compound was obtained after kneading with a twin-screw extruder of φ30 mm according to the “formulation of B layer” described in Table 1. The extruder set temperature, screw rotation speed and extrusion speed during compounding are shown in Table 1. Each compound thus obtained was melt-extruded into a film using a T-die type single screw extruder with of φ40 mm. The extruder set temperature, the screw rotation speed and the extrusion speed, and the set temperature of T-die at the time of film production are shown in Table 1.

Next, according to the apparatus configuration shown in FIG. 2, the film for the A layer was unwound from a reel toward the touch roll (rubber roll) and transported between the casting roll (metal roll) and the touch roll (rubber roll). At the same time, the film for the B layer after melt extrusion molding was sandwiched between the casting roll (metal roll) and the film for the A layer on the touch roll (rubber roll) which contained circulating water at the temperature shown in Table 1 so as to cool and solidify the film after the meld extrusion molding while laminating the film for the A layer to the film for the B layer after the melt extrusion molding in a peelable state. The multilayer film obtained was passed through a cooling roll containing circulating water at 30 to 50° C. and wound up on a reel.

In the above melt extrusion molding, the thickness of the film for the B layer was controlled by adjusting the interval of the exit (lip mouth) of the T-die and by adjusting the winding speed. In addition, the time required for the film to come into contact with the casting roll (metal roll) and the touch roll (rubber roll) after it was extruded from the exit of the T-die was set to 0.1 to 1 second.

The thickness of the B layer shown in Table 1 is the average value obtained by measuring at five arbitrary points in the TD direction with a dial sheet gauge after peeling off the A layer.

### 2. Preparation of Multilayer Films According to Examples 5 to 8 (Producing Method I)

### 2-1. Materials

### <For A Layer>

The PET film the same as that in Example 1 was prepared.

### <For B Layer>

The vinylidene fluoride-based resin (PVDF) and methacrylic acid ester-based resin (PMMA) the same as those in Example 1 were prepared.

### <For C Layer>

As a vinylidene fluoride-based resin (PVDF), trade name Kynar K720 produced by Arkema (homopolymer of vinylidene fluoride, melting point 169° C.) was prepared.

As the methacrylic acid ester-based resin (PMMA), trade name HIPET HBS000 produced by Mitsubishi Chemical Corporation (a methacrylic acid ester-based resin containing rubber components of butyl acrylate (n-BA) and butyl methacrylate (BMA)) was prepared.

As a triazine-based ultraviolet absorber, trade name Tinuvin 1600 produced by BASF was prepared.

### 2-2. Preparation of Multilayer Film

According to the test number, each compound for the B layer and for the C layer was obtained after kneading with a twin-screw extruder of φ30 mm according to the “formulation of B layer” and “formulation of C layer” described in Table 2. The extruder set temperature, screw rotation speed and extrusion speed during compounding are shown in Table 2. The compound for the B layer and the compound for the C layer were melt coextrusion molded into a two-layer film using a feed block-type T-die type multilayer extruder comprising two φ40 mm single-screw extruders and a feed block and a T-die attached to the tip. The extruder set temperature, the screw rotation speed and the extrusion speed, and the set temperature of T-die at the time of film production are shown in Table 2.

Next, according to the apparatus configuration shown in FIG. 2, the film for the A layer was unwound from a reel toward the touch roll (rubber roll) and transported between the casting roll (metal roll) and the touch roll (rubber roll). At the same time, the two-layer film (the two-layer film of the B layer and the C layer) after the melt coextrusion molding was sandwiched between the casting roll (metal roll) and the film for the A layer on the touch roll (rubber roll) which contained circulating water at the temperature shown in Table 2 such that the C layer was in contact with the casting roll (metal roll), and the B layer was in contact with the A layer, so as to cool and solidify the two-layer film after the melt coextrusion molding while laminating the film for the A layer to the side of the B layer of the two-layer film after the melt coextrusion molding in a peelable state. The multilayer film obtained was passed through a cooling roll containing circulating water at 30 to 50° C. and wound up on a reel.

In the above melt extrusion molding, the thickness of the two-layer film (the two-layer film of the B layer and the C layer) was controlled by adjusting the interval of the exit (lip mouth) of the T-die and by adjusting the winding speed. In addition, the time required for the two-layer film to come into contact with the casting roll (metal roll) and the touch roll (rubber roll) after it was extruded from the exit of the T-die was set to 0.1 to 1 second.

The thickness of each of the B layer and the C layer shown in Table 2 is the average value obtained by observing a cross-section cut in the TD direction with a microscope at five arbitrary points after peeling off the A layer.

### 3. Preparation of Single-Layer Film According to Comparative Example 1 (Producing Method I)

### 3-1. Material

### <For A Layer>

A layer was not used.

### <For B Layer>

The vinylidene fluoride-based resin (PVDF) and methacrylic acid ester-based resin (PMMA) the same as those in Example 1 were prepared.

### <For C Layer>

C layer was not used.

### 3-2. Preparation of Single-Layer Film

According to the test number, the compound was obtained after kneading with a twin-screw extruder of φ30 mm according to the “formulation of B layer” described in Table 3. The extruder set temperature, screw rotation speed and extrusion speed during compounding are shown in Table 3. The resulting compound was melt extrusion molded into a film using a T-die type single-screw extruder of φ40 mm. The extruder set temperature, the screw rotation speed and the extrusion speed, and the set temperature of T-die at the time of film production are shown in Table 3.

The film for the B layer after the melt extrusion molding was sandwiched between the casting roll (metal roll) and the touch roll (rubber roll) which contained circulating water at the temperature shown in Table 3 so as to cool and solidify the film after the meld extrusion molding, and a single-layer film of only the B layer was obtained. The single-layer film obtained was passed through a cooling roll containing circulating water at 30 to 50° C. and wound up on a reel.

In the above melt extrusion molding, the thickness of the single-layer film was controlled by adjusting the interval of the exit (lip mouth) of the T-die and by adjusting the winding speed. In addition, the time required for the single-layer film to come into contact with the casting roll (metal roll) and the touch roll (rubber roll) after it was extruded from the exit of the T-die was set to 0.1 to 1 second.

The thickness of the B layer shown in Table 3 is the average value obtained by measuring at five arbitrary points in the TD direction with a dial sheet gauge.

### 4. Preparation of Multilayer Film According to Comparative Example 2 (Producing Method I)

### 4-1. Material

### <For A Layer>

A layer was not used.

### <For B Layer>

The vinylidene fluoride-based resin (PVDF) and methacrylic acid ester-based resin (PMMA) the same as those in Example 1 were prepared.

### <For C Layer>

The vinylidene fluoride-based resin (PVDF), methacrylic acid ester-based resin (PMMA), and triazine-based ultraviolet absorber the same as those in Example 5 were prepared.

### 4-2. Preparation of Multilayer Film

According to the test number, each compound for the B layer and for the C layer was obtained after kneading with a twin-screw extruder of φ30 mm according to the “formulation of B layer” and “formulation of C layer” described in Table 3. The extruder set temperature, screw rotation speed and extrusion speed during compounding are shown in Table 3. The compound for the B layer and the compound for the C layer were melt coextrusion molded into a two-layer film using a feed block-type T-die multilayer extruder comprising two φ40 mm single-screw extruders and a feed block and a T-die attached to the tip. The extruder set temperature, the screw rotation speed and the extrusion speed, and the set temperature of T-die at the time of film production are shown in Table 3.

The two-layer film (the two-layer film of the B layer and the C layer) after the melt coextrusion molding was sandwiched between the casting roll (metal roll) and the touch roll (rubber roll) which contained circulating water at the temperature shown in Table 3 such that the C layer was in contact with the casting roll (metal roll), and the B layer was in contact with the touch roll (rubber roll), so as to cool and solidify the two-layer film after the melt coextrusion molding, and to obtain a multilayer film. The multilayer film obtained was passed through a cooling roll containing circulating water at 30 to 50° C. and wound up on a reel.

In the above melt extrusion molding, the thickness of the two-layer film (the two-layer film of the B layer and the C layer) was controlled by adjusting the interval of the exit (lip mouth) of the T-die and by adjusting the winding speed. In addition, the time required for the two-layer film to come into contact with the casting roll (metal roll) and the touch roll (rubber roll) after it was extruded from the exit of the T-die was set to 0.1 to 1 second.

The thickness of each of the B layer and the C layer shown in Table 3 is the average value obtained by observing a cross-section cut in the TD direction with a microscope at five arbitrary points after peeling off the A layer.

### 5. Preparation of Multilayer Film According to Comparative Example 3 (Producing Method II)

### 5-1. Material

### <For A Layer>

The PET film the same as that in Example 1 was prepared.

### <For B Layer>

The vinylidene fluoride-based resin (PVDF) and methacrylic acid ester-based resin (PMMA) the same as those in Example 1 were prepared.

### <For C Layer>

The vinylidene fluoride-based resin (PVDF), methacrylic acid ester-based resin (PMMA), and triazine-based ultraviolet absorber the same as those in Example 5 were prepared.

### 5-2. Preparation of Multilayer Film

According to the “formulation of B layer” shown in Table 3, each component was dissolved in N-methyl-2-pyrrolidone (NMP) and heated to boiling to obtain a uniform coating liquid. The obtained coating liquid for the B layer was applied on the PET film for the A layer with a solution casting die. The thickness was evened with a doctor blade, and a two-layer film of the A layer the and B layer was obtained by heat drying at 130° C. for 30 minutes under reduced pressure. Next, according to the “formulation of C layer” shown in Table 3, each component was dissolved in isopropyl alcohol and heated to boiling to obtain a uniform coating liquid. The obtained coating solution for the C layer was applied on the B layer of the two-layer film previously prepared using a solution casting die. The thickness was evened with a doctor blade, and a multilayer film composed of the A layer, the B layer and the C layer was obtained by heat drying at 50° C. for 30 minutes under reduced pressure.

The thickness of each of the B layer and the C layer shown in Table 3 is the average value obtained by observing a cross-section cut in the TD direction with a microscope at five arbitrary points after peeling off the A layer.

### 6. Preparation of Multilayer Film According to Comparative Example 4 (Producing Method II)

### 6-1. Materials

### <For A Layer>

A smooth biaxially stretched film made of polyethylene terephthalate (PET) (trade name TA30 produced by Toray Plastics (America), Inc.) was prepared. The thickness of the film was measured at five arbitrary locations in the TD direction with a dial sheet gauge, and the average value was taken as the measured value. The result is shown in Table 3.

### <For B Layer>

As a vinylidene fluoride-based resin (PVDF), Kynar 500 (a PVDF homopolymer having a melting point of 160° C.) produced by Arkema was prepared.

As a methacrylic acid ester-based resin (PMMA), ELVACITE 2042 (polymethyl methacrylate having a Tg of 65° C.) produced by Lucite International Specialty Polymers & Resins was prepared.

### <For C Layer>

As a methacrylic acid ester-based resin (PMMA), ELVACITE 2042 (polymethyl methacrylate having a Tg of 65° C.) produced by Lucite International Specialty Polymers & Resins was prepared.

As a benzotriazole-based ultraviolet absorber, (trade name Tinuvin 928 produced by BASF was prepared.

### 6-2. Preparation of Multilayer Film

According to the “formulation of B layer” shown in Table 3, each component was dissolved NMP and heated to boiling to obtain a uniform coating liquid. The obtained coating liquid for the B layer was applied on the PET film for the A layer with a solution casting die. The thickness was evened with a doctor blade, and a two-layer film of the A layer the and B layer was obtained by heat drying at 130° C. for 30 minutes under reduced pressure. Next, according to the “formulation of C layer” shown in Table 3, each component was dissolved in isopropyl alcohol and heated to boiling to obtain a uniform coating liquid. The obtained coating solution for the C layer was applied on the B layer of the two-layer film previously prepared using a solution casting die. The thickness was evened with a doctor blade, and a multilayer film composed of the A layer, the B layer and the C layer was obtained by heat drying at 50° C. for 30 minutes under reduced pressure.

The thickness of each of the B layer and the C layer shown in Table 3 is the average value obtained by observing a cross-section cut in the TD direction with a microscope at five arbitrary points after peeling off the A layer.

### 7. Characteristic Evaluation

### 7-1. Film Formability

The film formability of each film prepared under the above conditions was evaluated according to the following criteria.
o (circle): No holes and good thickness accuracy
x (cross): Holes occurred or thickness accuracy was poor

The thickness accuracy was judged according to the following criteria. The thickness of the film (film after peeling off the A layer if it had the A layer) was measured at 10 arbitrary points in the TD direction with a dial sheet gauge. When the average value was 40 μm±4 μm and |(each measured value)−(average value)| was all within 5 μm, it was judged that “thickness accuracy is good”. Other cases were regarded as “poor thickness accuracy”.

The results are shown in Tables 1 to 3.

### 7-2. Thermal Dimensional Change of Film for A Layer

With respect to each film for the A layer prepared above, the dimensional change rate in the MD direction and the TD direction after being left to stand at 120° C. for 5 minutes was measured based on JIS K7133: 1999. The results are shown in Tables 1 to 3.

### 7-3. Peel Strength when Peeling A Layer from B Layer

With respect to each film prepared under the above conditions, the peel strength (average peel strength) when peeling the A layer from the B layer was measured using a tensile and compression tester (Strograph VE1D produced by Toyo Seiki Seisakusho Co., Ltd.) by performing a 180° peel test according to the measurement procedure described above. Five samples were used. The results are shown in Tables 1 to 3.

### 7-4. Arithmetic Mean Height Sa₁, Sa₂ of the Surface of B Layer that was in Contact with A Layer

### (a) Large Area Surface Roughness Measurement

For each film prepared under the above conditions, using a scanning white light interference microscope “Wyko™” (NT1100 produced by Bruker Japan K.K.), the arithmetic mean height Sa₁ according to ISO25178-604 of the surface of the B layer that was in contact with the A layer was measured after peeling off the A layer. For Comparative Examples 1 and 2, which were not provided with an A layer, the arithmetic mean height Sa₁ was measured for the surface of the B layer that was in contact with the touch roll.

The measurement conditions were as follows.
Measurement mode: VSI
Measurement area: 4.8 mm×3.7 mm
Correction: Cylinder & Tilt/Data Restore

The results are shown in Tables 1 to 3.

### (b) Small Area Surface Roughness Measurement

For each film prepared under the above conditions, using a laser microscope (VK-X100 produced by KEYENCE CORPORATION), the arithmetic mean height Sa₂ according to ISO25178-607 of the surface of the B layer which was in contact with the A layer was measured after peeling off the A layer. In addition, in Comparative Examples 1 and 2, which were not provided with an A layer, the arithmetic mean height Ss₂ was measured for the surface of the B layer that was in contact with the touch roll. The measurement conditions were as follows.
Head: VK-X110
Measuring mode: transparent object
Measurement area: 0.3 mm×0.3 mm
Correction: None
Filter: OFF

The results are shown in Tables 1 to 3.

### 7-5. Arithmetic Mean Height Sa₃, Sa₄ of the Surface of A Layer that was in Contact with B Layer

### (a) Large Area Surface Roughness Measurement

For each film prepared under the above conditions, using a scanning white light interference microscope “Wyko™” (NT1100 produced by Bruker Japan K.K.), the arithmetic mean height Sa₃ according to ISO25178-604 of the surface of the A layer that was in contact with the B layer was measured after peeling off the A layer. The measurement conditions were as follows.
Measurement mode: VSI
Measurement area: 4.8 mm×3.7 mm
Correction: Cylinder & Tilt/Data Restore

The results are shown in Tables 1 to 3.

### (b) Small Area Surface Roughness Measurement

For each film prepared under the above conditions, using a laser microscope (VK-X100 produced by KEYENCE CORPORATION), the arithmetic mean height Sa₄ according to ISO25178-607 of the surface of the A layer which was in contact with the B layer was measured after peeling off the A layer. The measurement conditions were as follows.
Head: VK-X110
Measuring mode: transparent object
Measurement area: 0.3 mm×0.3 mm
Correction: None
Filter: OFF

The results are shown in Tables 1 to 3.

### 7-6. HAZE

The A layer was peeled off from each film prepared under the above conditions. The HAZE value (before heating) according to JIS K7136:2000 at 25° C. was measured for the B layer (if the C layer was present, the two-layer film of the B layer and the C layer) after peeling off the A layer. A haze meter NDH7000 (produced by Nippon Denshoku Industries Co., Ltd.) was used for the measurement. In addition, for Comparative Examples 1 and 2, which were not provided with an A layer, measurement was performed as they were. The results are shown in Tables 1 to 3.

### 7-7. Nominal Tensile Strain at Break of B Layer (or B Layer+C Layer) after Peeling Off A Layer

The A layer was peeled off from each film prepared under the above conditions. A tensile test was performed according to JIS K7127: 1999 (specimen type 2) for the B layer (if the C layer was present, the two-layer film of the B layer and the C layer) after peeling off the A layer. The nominal tensile strain at break in the MD direction and the TD direction at 25° C. was measured using a tensile and compression tester (Strograph VE1D produced by Toyo Seiki Seisakusho Co., Ltd.). In addition, for Comparative Examples 1 and 2, which were not provided with the A layer, measurement was performed as they were. The measurement conditions were as follows.
Measurement sample size: length 150 mm×width 10 mm
Gauge length (=initial chuck distance): 50 mm
Tensile speed: 200 mm/min

The number of samples was 5 each for the MD direction and the TD direction, respectively. The results are shown in Tables 1 to 3.

### 7-8. Elmendorf Tear Resistance

The A layer was peeled off from each film prepared under the above conditions. With respect to the B layer (if the C layer was present, a two-layer film of the B layer and the C layer) after peeling off the A layer, the Elmendorf tear resistance was measured according to JIS K7128-2:1998 using a digital Elmendorf tear tester (SA-W produced by Toyo Seiki Seisaku-sho, Ltd.). In addition, for Comparative Examples 1 and 2, which were not provided with the A layer, measurement was performed as they were. The measurement conditions were as follows.
Measurement sample size: 75 mm×63 mm (rectangular test piece)
20 mm slit in the center
Tear direction: MD direction and TD direction

The number of samples was 5 each for the MD direction and the TD direction. The results are shown in Tables 1 to 3.

### 7-9. Image Clarity

For each film prepared under the above conditions, indium was sputtered at an optical density of 1.5 on the surface of the B layer that was not in contact with the A layer (if the C layer was present, the surface of the C layer that was not in contact with the B layer). Next, after peeling off the A layer, for the surface of the B layer that was in contact with the A layer, image sharpness was measured according JIS K 7374:2007 using an image clarity meter (ICM-1T produced by Suga Test Instruments Co., Ltd.). Specifically, light from a light source was passed through a slit with a width of 0.03 mm and converted into parallel rays using a lens. Then, the light was reflected by the surface of the B layer that was in contact with the A layer at both an incident angle and a light receiving angle of 60°, thereby forming an image on an optical comb having a width of 0.125 mm, which was received by a light receiver. The image clarity C_{0.125} at an optical comb width of 0.125 mm was calculated by the following formula.

C_{0.125}=(M_{0.125}−m_{0.125})/(M_{0.125}+m_{0.125})×100
M_{0.125}: Maximum amount of light received at optical comb width of 0.125 mm
m_{0.125}: Minimum amount of light received at optical comb width of 0.125 mm

The results were evaluated according to the following criteria.
oo (double circle): C_{0.125} was 30 or more
o (circle): 10 or more and less than 30
x (cross): less than 10

The results are shown in Tables 1-3.

Incidentally, for Comparative Example 1, which was not provided with the A layer, indium was sputtered on the surface of the B layer that was in contact with the metal roll, and then the image clarity was measured for the surface of the B layer that was in contact with the touch roll. For Comparative Example 2, which was not provided with the A layer, indium was sputtered on the surface of the C layer that was in contact with the metal roll, and then the image clarity was measured for the surface of the B layer that was in contact with the touch roll.

### 7-10. Stretch Lamination Ability

For each film prepared under the above conditions, on the surface of the B layer that was not in contact with the A layer (if there was the C layer, the surface of the C layer that was not in contact with the B layer), an adhesive layer with a thickness of 25 μm was formed. For films provided with the A layer, the A layer was peeled off. Each film was then attached to a flat plate while being stretched by 1.2 times in both the MD and TD directions. The stretch lamination ability of the film after attaching was evaluated according to the following criteria.
o (circle): Neither tearing nor perforation occurred.
X (cross): Tearing or perforation occurred.

The results are shown in Tables 1 to 3.

TABLE 1

| | | | Example 1 | Example 2 | Example 3 | Example 4 |
|---|---|---|---|---|---|---|
| Producing method | | | I | I | I | I |
| Design of | Formulation of | Film grade | T60 | T60 | T60 | T60 |
| A layer | A layer | Resin type | PET | PET | PET | PET |
| | | Formulation amount [mass %] | 100 | 100 | 100 | 100 |
| | Thickness of A layer [μm] | | 50 | 50 | 50 | 50 |
| Design of | Formulation of | Type of vinyldene fluoride-based resins | Kynar | Kynar | Kynar | Kynar |
| B layer | B layer | | 1000HD | 1000HD | 1000HD | 1000HD |
| | | Formulation amount [parts by mass] | 70 | 70 | 70 | 60 |
| | | Type of methacrylic acid ester-based resins | SUMIPEX | SUMIPEX | SUMIPEX | SUMIPEX |
| | | | MGSS | MGSS | MGSS | MGSS |
| | | Formulation amount [parts by mass] | 30 | 30 | 30 | 40 |
| | Thickness of B layer [μm] | | 40 | 40 | 40 | 40 |
| Design of | Formulation of | Type of vinyldene fluonde-based resins | None | None | None | None |
| C layer | C layer | Formulation amount [parts by mass] | | | | |
| | | Type of methacrylic acid ester-based resins | | | | |
| | | Formulation amount (parts by mass] | | | | |
| | | Type of ultraviolet absorber | | | | |
| | | Formulation amount [parts by mass] | | | | |
| | Thickness of C layer [μm] | | | | | |
| Producing | B layer | Extruder set temperature for compounding [° C.] | 240 | 240 | 240 | 240 |
| conditions for | | Screw rotation speed during compounding [RPM] | 340 | 340 | 340 | 340 |
| each layer | | Extrusion speed during compounding [kg/h] | 52.6 | 52.6 | 52.6 | 52.6 |
| | | Extruder set temperature for film production [° C.] | 240 | 250 | 230 | 240 |
| | | Screw rotation speed during film production [RPM] | 90 | 90 | 90 | 90 |
| | | Extrusion speed during film production [kg/h] | 27 | 27 | 27 | 27 |
| | C layer | Extruder set temperature for compounding [° C.] | None | None | None | None |
| | | Screw rotation speed during compounding (RPM] | | | | |
| | | Extrusion speed during compounding [kg/h] | | | | |
| | | Extruder set temperature for film production [° C.] | | | | |
| | | Screw rotation speed during film production [RPM] | | | | |
| | | Extrusion speed during film production [kg/h] | | | | |
| | Set temperature of extruder/T-die [° C.] | | 240 | 250 | 230 | 240 |
| | Set temperature of circulating water | | 50 | 50 | 50 | 50 |
| | for casting roll and touch roll [° C.] | | | | | |
| Film | Producing method I | | ○ | ○ | ○ | ○ |
| formability | Producing method II | | — | — | — | — |
| Film | Thermal dimensional change of A layer (MD/TD) [%] | | 2.0/0.9 | 2.0/0.9 | 2.0/0.9 | 2.0/0.9 |
| Properties | Peel strength when peeling layer A from layer B [N/25 mm] | | 0.1 | 0.1 | 0.1 | 0.05 |
| | Arithmetic mean height Sa₁ [nm] of B layer surface/Large area | | 40 | 10 | 80 | 40 |
| | Arithmetic mean height Sa₁ [nm] of B layer surface/Small area | | 30 | 10 | 70 | 20 |
| | Arithmetic mean height Sa₂ [nm] of A layer surface/Large area | | 32 | 32 | 32 | 32 |
| | Arithmetic mean height Sa₂ [nm] of A layer surface/Small area | | 12 | 12 | 12 | 12 |
| | HAZE value [%] of B layer (or laminate of B layer and C layer) after | | 1.7 | 2.0 | 1.9 | 0.9 |
| | peeling A layer | | | | | |
| | Nominal tensile | MD (flow) direction | 410 | 410 | 410 | 310 |
| | strain at break [%] | TD (width) direction | 490 | 490 | 490 | 380 |
| | Elmendorf tear | MD (flow) direction | 10000 | 10000 | 10000 | 9000 |
| | resistance [N/m] | TD (width) direction | 12000 | 12000 | 12000 | 11000 |

| | | | | | |
|---|---|---|---|---|---|
| Film | Image clarity | ○○ | ○○ | ○ | ○○ |
| Performance | Stretch lamination ability | ○ | ○ | ○ | ○ |

TABLE 2

| | | | Example 5 | Example 6 | Example 7 | Example 8 |
|---|---|---|---|---|---|---|
| Producing method | | | I | I | I | I |
| Design of | Formulation of | Film grade | T60 | T60 | T60 | T60 |
| A layer | A layer | Resin type | PET | PET | PET | PET |
| | | Formulation amount [mass %] | 100 | 100 | 100 | 100 |
| | Thickness of A layer [μm] | | 50 | 50 | 50 | 50 |
| Design of | Formulation of | Type of vinylidene fluoride-based resins | Kynar | Kynar | Kynar | Kynar |
| B layer | B layer | | 1000HD | 1000HD | 1000HD | 1000HD |
| | | Formulation amount [parts by mass] | 70 | 70 | 70 | 60 |
| | | Type of methacrylic acid ester-based resins | SUMIPEX | SUMIPEX | SUMIPEX | SUMIPEX |
| | | | MGS5 | MGS5 | MGSS | MGSS |
| | | Formulation amount [parts by mass] | 30 | 30 | 30 | 40 |
| | | Thickness of B layer [μm] | 13 | 13 | 13 | 13 |
| Design of | Formulation of | Type of vinylidene fluoride-based resins | Kynar K720 | Kynar K720 | Kynar K720 | Kynar K720 |
| C layer | C layer | Formulation amount [parts by mass] | 20 | 20 | 20 | 20 |
| | | Type of methacrylic acid ester-based resins | HBS000 | HBS000 | HBS000 | HBS000 |
| | | Formulation amount [parts by mass] | 77.9 | 77.9 | 77.9 | 77.9 |
| | | Type of ultraviolet absorber | Tinovin | Tinuvin | Tinuvin | Tinuvin |
| | | | 1600 | 1600 | 1600 | 1600 |
| | | Formulation amount [parts by mass] | 2.1 | 2.1 | 2.1 | 2.1 |
| | Thickness of C layer [μm] | | 27 | 27 | 27 | 27 |
| Producing | B layer | Extruder set temperature for compounding [° C.] | 240 | 240 | 240 | 240 |
| conditions for | | Screw rotation speed during compounding [RPM] | 340 | 340 | 340 | 340 |
| each layer | | Extrusion speed during compounding [kg/h] | 52.6 | 52.6 | 52.6 | 52.6 |
| | | Extruder set temperature for film production [° C.] | 240 | 250 | 230 | 240 |
| | | Screw rotation speed during film production [RPM] | 30 | 30 | 30 | 30 |
| | | Extrusion speed during film production [kg/h] | 8.9 | 8.9 | 8.9 | 8.9 |
| | C layer | Extruder set temperature for compounding [° C.] | 240 | 240 | 240 | 240 |
| | | Screw rotation speed during compounding (RPM] | 340 | 340 | 340 | 340 |
| | | Extrusion speed during compounding [kg/h] | 52.6 | 52.6 | 52.6 | 52.6 |
| | | Extruder set temperature for film production [° C.] | 220 | 230 | 210 | 220 |
| | | Screw rotation speed during film production [RPM] | 40 | 40 | 40 | 40 |
| | | Extrusion speed during film production [kg/h] | 11.2 | 11.2 | 11.2 | 11.2 |
| | Set temperature of extruder/T-die [° C.] | | 240 | 250 | 230 | 240 |
| | Set temperature of circulating water | | 50 | 50 | 50 | 50 |
| | for casting roll and touch roll [° C.] | | | | | |
| Film | Producing method I | | ○ | ○ | ○ | ○ |
| formability | Producing method II | | — | — | — | — |
| Film | Thermal dimensional change of A layer (MD/TD) [%] | | 2.0/0.9 | 2.0/0.9 | 2.0/0.9 | 2.0/0.9 |
| Properties | Peel strength when peeling layer A from layer B [N/25 mm] | | 0.1 | 0.1 | 0.01 | 0.04 |
| | Arithmetic mean height Sa₁ [nm] of B layer surface/Large area | | 40 | 10 | 80 | 40 |
| | Arithmetic mean height Sa₁ [nm] of B layer surface/Small area | | 30 | 10 | 70 | 40 |
| | Arithmetic mean height Sa₂ [nm] of A layer surface/Large area | | 32 | 32 | 32 | 32 |
| | Arithmetic mean height Sa₂ [nm] of A layer surface/Small area | | 12 | 12 | 12 | 12 |
| | HAZE value [%] of B layer (or laminate of B layer and C layer) after | | 1.8 | 2.1 | 1.9 | 1.1 |
| | peeling A layer | | | | | |
| | Nominal tensile | MD (flow) direction | 220 | 220 | 220 | 140 |
| | strain at break [%] | TD (width) direction | 230 | 230 | 230 | 170 |
| | Elmendorf tear | MD (flow) direction | 9000 | 9000 | 9000 | 8000 |
| | resistance [N/m] | TD (width) direction | 11000 | 11000 | 11000 | 10000 |

| | | | | | |
|---|---|---|---|---|---|
| Film | Image clarity | ○○ | ○○ | ○ | ○○ |
| Performance | Stretch lamination ability | ○ | ○ | ○ | ○ |

TABLE 3

| | | | Comparative | Comparative | Comparative | Comparative |
|---|---|---|---|---|---|---|
| | | | Example 1 | Example 2 | Example 3 | Example 4 |
| Producing method | | | I | I | II | II |
| Design of | Formulation of | Film grade | None | None | T60 | TA30 |
| A layer | A layer | Resin type | | | PET | PET |
| | | Formulation amount [mass %] | | | 100 | 100 |
| | Thickness of A layer [μm] | | | | 50 | 50 |
| Design of | Formulation of | Type of vinyldense fluoride-based resins | Kynar | Kynar | Kynar | Kynar |
| B layer | B layer | | 1000HD | 1000HD | 1000HD | 500 |
| | | Formulation amount [parts by mass] | 70 | 70 | 70 | 70 |
| | | Type of methacrylic acid ester-based resins | SUMIPEX | SUMIPEX | SUMIPEX | ELVACITE |
| | | | MGSS | MGSS | MGSS | 2042 |
| | | Formulation amount [parts by mass] | 30 | 30 | 30 | 30 |
| | Thickness of B layer [μm] | | 40 | 13 | 13 | 32 |
| Design of | Formulation of | Type of vinylidene fluoride-based resins | None | Kynar K720 | Kynar K720 | — |
| C layer | C layer | Formulation amount [parts by mass] | | 20 | 20 | 0 |
| | | Type of methacrylic acid ester-based resins | | HBS000 | HBS000 | ELVACITE 2042 |
| | | Formulation amount [parts by mass] | | 77.9 | 77.9 | 99.5 |
| | | Type of ultraviolet absorber | | Tinuvin 1600 | Tinuvin 1600 | Tinuvin 928 |
| | | Formulation amount (parts by mass] | | 2.1 | 2.1 | 0.5 |
| | Thickness of C layer [μm] | | | 27 | 27 | 8 |
| Producing | B layer | Extruder set temperature for compounding [° C.] | 240 | 240 | None | None |
| conditions for | | Screw rotation speed during compounding [RPM] | 340 | 340 | | |
| each layer | | Extrusion speed during compounding [kg/h] | 52.6 | 52.6 | | |
| | | Extruder set temperature for film production [° C.] | 220 | 220 | | |
| | | Screw rotation speed during film production [RPM] | 90 | 30 | | |
| | | Extrusion speed during film production [kg/h] | 27 | 8.9 | | |
| | C layer | Extruder set temperature for compounding [° C.] | None | 240 | | |
| | | Screw rotation speed during compounding (RPM] | | 340 | | |
| | | Extrusion speed during compounding [kg/h] | | 52.6 | | |
| | | Extruder set temperature for film production [° C.] | | 200 | | |
| | | Screw rotation speed during film production [RPM] | | 40 | | |
| | | Extrusion speed during film production [kg/h] | | 11.2 | | |
| | Set temperature of extruder/T-die [° C.] | | 220 | 220 | | |
| | Set temperature of circulating water | | 50 | 50 | | |
| | for casting roll and touch roll [° C.] | | | | | |
| Film | Producing method I | | ○ | ○ | — | — |
| formability | Producing method II | | — | — | x | ○ |
| Film | Thermal dimensional change of A layer (MD/TD) [%] | | | | 2.0/0.9 | 1.4/1.2 |
| Properties | Peel strength when peeling layer A from layer B [N/25 mm] | | — | — | — | 0.05 |
| | Arithmetic mean height Sa₁ [nm] of B layer surface/Large area | | 120 | 150 | — | 30 |
| | Arithmetic mean height Sa₁ [nm] of B layer surface/Small area | | 60 | 60 | — | 10 |
| | Arithmetic mean height Sa₂ [nm] of A layer surface/Large area | | None | None | 32 | 20 |
| | Arithmetic mean height Sa₂ [nm] of A layer surface/Small area | | None | None | 12 | 10 |
| | HAZE value [%] of B layer (or laminate of B layer and C layer) after | | 1.8 | 1.7 | 1.7 | 4.0 |
| | peeling A layer | | | | | |
| | Nominal tensile | MD (flow) direction | 410 | 220 | — | 45 |
| | strain at break [%] | TD (width) direction | 490 | 230 | — | 30 |
| | Elmendorf tear | MD (flow) direction | 10000 | 9000 | — | 4500 |
| | resistance [N/m] | TD (width) direction | 12000 | 11000 | — | 4500 |

| | | | | | |
|---|---|---|---|---|---|
| Film | Image clarity | x | x | — | ○○ |
| Performance | Stretch lamination ability | ○ | ○ | — | x |

### DISCUSSION

In Examples 1 to 8, regardless of the presence or absence of the C layer, the undulation (large area surface roughness) of the surface of the B layer that was in contact with the A layer after peeling off the A layer was small, and the image clarity was high. In addition, the B layer (the two-layer film of the B layer and the C layer if the C layer was present) had a high nominal tensile strain at break, so it was excellent in tensile physical properties. Therefore, it was also excellent in stretch lamination ability.

Among them, in Examples 2 and 6, the set temperature of the T-die at the time of film production was high, and the smooth surface of the A layer was successfully transferred, so that the undulation was particularly small.

Comparing Example 4 and Example 8, Example 8 having an acrylic-rich C layer had a lower nominal tensile strain at break and was easier to break.

Comparing Example 5 and Example 8, Example 8, in which the amount of PMMA in the B layer was higher, had a lower nominal tensile strain at break and was easier to break. The same can be seen by comparing Example 1 and Example 4.

Comparative Examples 1 and 2 did not have an A layer. As a result, the undulation (large area surface roughness) of the surface of the B layer increased, and the image clarity decreased.

In Comparative Example 3, a multilayer film was produced by a casting method using PVDF and PMMA similarly to Examples, but perforation was occurred and the thickness accuracy was poor, so physical properties of the film were not evaluated.

In Comparative Example 4, a multilayer film was produced using PVDF and PMMA suitable for film production by the casting method. However, the tensile physical properties of the two-layer laminate of the B layer and the C layer were lowered, and the stretch lamination ability was deteriorated.

### DESCRIPTION OF REFERENCE NUMERALS

1, 2 Multilayer film
10 A layer
20 B layer
30 C layer
200 Producing apparatus for multilayer film
210 T-die
212 Exit
220 Touch roll
230 Casting roll
240 Reel
250 Cooling roll
260 Film for A layer
270 Film for B layer
280 Multilayer film
290 Reel

1. A multilayer film, comprising a B layer which comprises a vinylidene fluoride-based resin, and an A layer laminated on a surface of the B layer in a peelable state, wherein the A layer is composed of a thermoplastic resin film having a dimensional change rate after being left to stand at 120° C. for 5 minutes of 5% or less in MD direction and 3% or less in TD direction measured according to JIS K7133: 1999; wherein an arithmetic mean height Sa1 after peeling off the A layer measured with a non-contact interference microscope according to ISO25178-604 in an area of 4.8 mm×3.7 mm on a surface of the B layer that was in contact with the A layer is 80 nm or less; and wherein when a tensile test is performed according to JIS K7127: 1999 (specimen type 2) on the B layer after the A layer is peeled off, a nominal tensile strain at break at 25° C. is 100% or more in both the MD and TD directions.

2. The multilayer film according to claim 1, wherein the arithmetic mean height Sa1 after peeling off the A layer measured with the non-contact interference microscope according to ISO25178-604 in the area of 4.8 mm×3.7 mm on the surface of the B layer that was in contact with the A layer, and an arithmetic mean height Sa2 after peeling off the A layer measured with a laser microscope according to ISO25178-607 in an area of 0.3 mm×0.3 mm on the surface of the B layer that was in contact with the A layer satisfy |Sa1-Sa2|≤30 nm.

3. The multilayer film according to claim 1, wherein the B layer comprises a copolymer of vinylidene fluoride and hexafluoropropene, and/or polyvinylidene fluoride.

4. The multilayer film according to claim 1, wherein the B layer comprises the vinylidene fluoride-based resin which comprises a copolymer of vinylidene fluoride and hexafluoropropene, and/or polyvinylidene fluoride; and a methacrylic acid ester-based resin; and wherein with respect to a total of 100 parts by mass of the vinylidene fluoride-based resin and the methacrylic acid ester-based resin, the B layer comprises 51 parts by mass or more of the vinylidene fluoride-based resin and 49 parts by mass or less of the methacrylic acid ester-based resin.

5. The multilayer film according to claim 1, wherein the thickness of the B layer is 5 μm or more and 200 μm or less.

6. The multilayer film according to claim 1, wherein the thermoplastic resin comprised in the A layer is one or two or more selected from polyethylene terephthalate, polypropylene, and polyamide.

7. The multilayer film according to claim 1, wherein the A layer is a biaxially stretched film.

8. The multilayer film according to claim 1, wherein an arithmetic mean height Sa3 after peeling off the A layer measured with the non-contact interference microscope according to ISO25178-604 in an area of 4.8 mm×3.7 mm on a surface of the A layer that was in contact with the B layer is 80 nm or less.

9. The multilayer film according to claim 1, wherein a surface of the A layer that is in contact with the B layer is coated with a silicone-based release agent.

10. The multilayer film according to claim 1, wherein a thickness of the A layer is 5 μm or more and 200 μm or less.

11. The multilayer film according claim 1, wherein a C layer comprising a resin component which comprises at least a methacrylic acid ester-based resin is laminated on a surface of the B layer opposite to the surface on which the A layer is laminated; and wherein when a tensile test is performed according to JIS K7127: 1999 (specimen type 2) on a two-layer laminate composed of the B layer and the C layer after peeling off the A layer, a nominal tensile strain at break at 25° C. is 100% or more in both the MD and TD directions.

12. The multilayer film according to claim 11, wherein the resin component of the C layer comprises a vinylidene fluoride-based resin.

13. The multilayer film according to claim 11, wherein the C layer comprises a vinylidene fluoride-based resin which comprises a copolymer of vinylidene fluoride and hexafluoropropene, and/or polyvinylidene fluoride; and a methacrylic acid ester-based resin; and wherein with respect to a total of 100 parts by mass of the vinylidene fluoride-based resin and the methacrylic acid ester-based resin, the C layer comprises 50 parts by mass or less of the vinylidene fluoride-based resin and 50 parts by mass or more of the methacrylic acid ester-based resin.

14. The multilayer film according to claim 11, wherein a thickness of the C layer is 5 μm or more and 200 μm or less.

15. The multilayer film according to claim 11, wherein the C layer comprises 0.1 to 10 parts by mass of an ultraviolet absorber based on a total of 100 parts by mass of all components in the C layer.

16. The multilayer film according to claim 15, wherein the ultraviolet absorber is a triazine-based compound and/or a benzotriazole-based compound.

17. A method for producing a multilayer film according to claim 1, comprising:
melt extrusion molding a raw material for forming the B layer from a T-die into a film; and
sandwiching the film after the melt extrusion molding between a casting roll and the A layer on a touch roll to cool and solidify the film after the melt extrusion molding while laminating the A layer to the film after the melt extrusion molding in a peelable state.

18. A method for producing a multilayer film according to claim 11, comprising:
melt coextrusion molding a raw material for forming the B-layer and a raw material for forming the C layer from a T-die into a two-layer film composed of the B layer and the C layer;
sandwiching the two-layer film after the melt coextrusion molding between a casting roll and the A layer on a touch roll such that the C layer is in contact with the casting roll to cool and solidify the two-layer film after the melt coextrusion molding while laminating the A layer to the B layer in a peelable state.
